(19) United States
(12) Patent Application Publication
(10) Pub. No.: US 2026/0332074 A1
(43) Pub. Date: Oct. 22, 2026

(54) MOTOR CONTROL DEVICE

(71) Applicant: ADVICS CO., LTD., Kariya-shi, Aichi-ken (JP)

(72) Inventor: Hikaru KAWAMURA, Kariya-shi, Aichi-ken (JP)

(73) Assignee: ADVICS CO., LTD., Kariya-shi, Aichi-ken (JP)

(21) Appl. No.: 19/101,152

(22) PCT Filed: Aug. 22, 2023
(86) PCT No.: PCT/JP2023/030214

§ 371 Date: Feb. 4, 2025

(30) Foreign Application Priority Data
Aug. 22, 2022 (JP) 2022-131452

(51) Int. Cl. H02P 21/18

(52) U.S. Cl. CPC H02P 21/18; H02P 2203/09; H02P 2207/05

(57) ABSTRACT

A motor control device includes a control unit that performs sensorless control of a brushless motor having three phases, and a determination unit that determines presence or absence of step-out of the brushless motor. The control unit executes the sensorless control based on the estimated d-axis output current Ids and the estimated q-axis output current Iqs, estimated d-axis and estimated q-axis instruction voltages Vdc and Vqc, and an estimated rotation speed. The determination unit calculates the determination voltage Vqj based on the estimated d-axis output current Ids and the estimated q-axis output current Iqs, and the estimated rotation speed. Occurrence of the step-out is determined when a voltage deviation hV, which is a difference between the determination voltage Voj and the estimated q-axis instruction voltage Vqc, reaches a determination threshold value. For example, the determination unit determines the determination threshold value to become larger the larger the estimated rotation speed.

### TECHNICAL FIELD

The present disclosure relates to a motor control device.

### BACKGROUND ART

Patent Literature 1 describes the following for the purpose of performing step-out detection with a simple configuration that eliminates the need to add a current detector or a voltage detector. A model voltage calculation unit 10 obtains the dq-axis model voltages vd* and vq* from the speed of the speed instruction of the PM motor and the dq-axis current of the current instruction using the PM motor model on the basis of the voltage equation of the PM motor 2, and a step-out determination unit 11 determines the presence or absence of step-out of the PM motor by comparing the model voltage with the voltage instructions vd and vq of the inverter. When calculating the model voltage, a dq-axis current detection value can be used instead of the current instruction of the PM motor.

Furthermore, the step-out determination can be performed using only the model voltage of the q-axis component.

When a brushless motor is operated properly, a state (synchronous state) in which the synchronous speed (the rotational speed of the magnetic field when the AC current is applied) is equal to the actual rotational speed of the rotor is obtained. When the load on the motor becomes excessively large, a state (step-out state) in which the synchronous speed and the actual rotational speed do not match may occur. In the step-out state, a deviation (error) occurs between the speed instruction (also referred to as “target rotational speed”) and the actual rotational speed. In Patent Literature 1, in the step-out determination, since the model voltage is calculated from the speed instruction (target rotational speed), an error may occur in the determination.

### CITATIONS LIST

### Patent Literature

Patent Literature 1: JP 2010-252503 A

### SUMMARY

### Technical Problems

An object of the present disclosure is to provide a motor control device that performs sensorless control of a brushless motor, in which step-out of the brushless motor can be reliably determined.

### SOLUTIONS TO PROBLEMS

A motor control device (MS) according to the present disclosure includes: a control unit (BC) that performs sensorless control of a brushless motor (BM) having three phases; and a determination unit (BH) that determines presence or absence of step-out of the brushless motor (BM).

In the motor control device (MS) according to the present disclosure, the control unit (BC) executes the sensorless control on the basis of an estimated d-axis output current and an estimated q-axis output current (Ids, Iqs), estimated d-axis and estimated q-axis instruction voltages (Vdc, Vqc), and an estimated rotation speed (ωs). Then, the determination unit (BH) calculates a determination voltage (Vqj) on the basis of the estimated d-axis output current and the estimated q-axis output current (Ids, Iqs), and the estimated rotation speed (ωs), and determines the occurrence of step-out when a voltage deviation (hV), which is a difference between the determination voltage (Vqj) and the estimated q-axis instruction voltage (Vqc), reaches a determination threshold value (Hs). For example, the determination unit (BH) determines the determination threshold value (Hs) to be larger the larger the estimated rotation speed (ωs).

In the motor control device (MS) according to the present disclosure, the determination unit (BH) determines the determination voltage (Vqj) on the assumption that the brushless motor (BM) is not out of step and is rotating at the estimated rotation speed (ωs). Specifically, the determination unit (BH) calculates a first component (Sv1=R·Iqs) corresponding to a voltage drop in the brushless motor (BM) on the basis of the estimated q-axis output current (Iqs), calculates a second component (Sv2=ωs (φ+Ld·Ids) ) corresponding to a counter electromotive voltage in the brushless motor (BM) on the basis of the estimated rotation speed (ωs) and the estimated d-axis output current (Ids), and determines the determination voltage (Vqj) as a sum (Vqj=Sv1+Sv2) of the first component (Sv1) and the second component (Sv2).

According to the above configuration, the estimated rotation speed ωs is adopted for the step-out determination of the brushless motor BM, and the voltage deviation hV is determined as a state quantity that appropriately expresses the extent of step-out. As a result, determination accuracy is improved, and reliable determination is executed.

### BRIEF DESCRIPTION OF DRAWINGS

FIG. 1 is a block diagram for explaining an embodiment of a motor control device MS.

FIG. 2 is a block diagram for explaining a determination unit BH.

### DESCRIPTION OF EMBODIMENTS

### Symbols of Configuring Members and the Like and Expression of Magnitude Relationship of Values

In the following description, configuring members, calculation processes, signals, characteristics, and values having the same symbol such as “BM” have the same functions. In addition, the magnitude relationship for the values of various state quantities (Hs, hV, etc.) is expressed on the basis of their magnitudes (absolute values). The current, the voltage, and the like are denoted with positive and negative (+/−) signs according to the rotating direction of the motor. For example, a positive sign is denoted when the motor is driven in the forward rotation direction, and a negative sign is denoted when the motor is driven in the reverse rotation direction. That is, the sign of the state quantity is different depending on the rotating direction of the motor. Furthermore, the voltage deviation hV is calculated as a difference between a determination voltage Vqj and an estimated q-axis instruction voltage Vqc, but the signs are reversed depending on the calculation method of the voltage deviation hV. That is, the sign of the voltage deviation hV is opposite between the case of being calculated with “hV=Vqj−Vac” and the case of being calculated with “hV=Vqc−Vqj”. Therefore, in the following description, the magnitude (or high and low) of the value is expressed with an absolute value (magnitude) of the value as a reference so as to avoid complication of the description.

### Embodiment of Motor Control Device MS

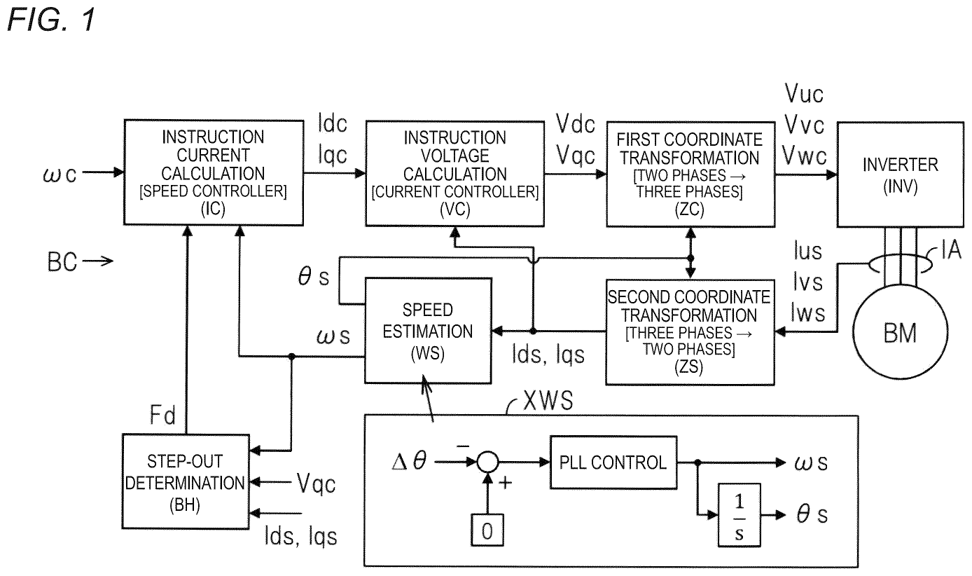

An embodiment of a motor control device MS will be described with reference to a block diagram of FIG. 1. A brushless motor BM is a synchronous motor provided with coils of three phases of a U phase, a V phase, and a W phase. The brushless motor BM is controlled (driven) by the motor control device MS. As the brushless motor BM, a sensorless type is adopted. Therefore, a position sensor (rotation angle sensor) that detects the position (i.e., the rotation angle) of the rotor of the brushless motor BM is not provided.

The motor control device MS that drives the brushless motor BM is configured by a control unit BC and a determination unit BH.

### Control Unit BC

Since the brushless motor BM is a sensorless type, sensorless control (also referred to as “sensorless vector control”) is executed in the control unit BC. The sensorless control is a known motor driving method (see e.g., JP 2008-011616 A, JP 2019-208329 A, and JP 2022-110307 A). Hereinafter, the control unit BC will be briefly described.

In the control unit BC, the brushless motor BM is driven by vector-controlling the current of the d-axis component and the current of the q-axis component orthogonal to the d-axis. “d-axis, q-axis” is a control axis in the rotational coordinates (also referred to as “d-q coordinates”) of vector control. The “d-axis” extends in the direction of the magnetic flux axis of the permanent magnet and the “q-axis” extends in the torque direction. Here, the d axis and the q axis are orthogonal to each other. In a brushless motor having a rotation angle sensor, an actual d-axis and an actual q-axis (“real d-axis, real q-axis” or “true d-axis, true q-axis”) are identified by a detection result (i.e., the rotation angle) of the rotation angle sensor.

Since the sensorless brushless motor BM does not include a rotation angle sensor, the d-axis and the q-axis are estimated, and vector control (i.e., sensorless vector control) is executed. In the sensorless control, the control axis estimated as the d-axis of the rotational coordinate is called “estimated d-axis (or, virtual d-axis)”. Furthermore, the control axis estimated as the q-axis of the rotational coordinate is called “estimated q-axis (or virtual q-axis)”. Similarly to the relationship between the real d-axis and the real q-axis, the estimated d-axis and the estimated q-axis are orthogonal to each other. Note that an error between the real d-axis and the real q-axis and the estimated d-axis and the estimated q-axis is expressed as an “axial error Δθ (angle error) ”.

The current instruction values in the estimated d-axis and the estimated q-axis are called “estimated d-axis instruction current Idc and estimated q-axis instruction current Iqc”. The currents generated in the estimated d-axis and the estimated q-axis in correspondence with the estimated d-axis instruction current Idc and estimated q-axis instruction current Iqc are called “estimated d-axis output current Ids and estimated q-axis output current Iqs”. The estimated d-axis output current Ids and estimated q-axis output current Iqs are estimated on the basis of the three-phase detection currents Ius, Ivs, and Iws (U-phase, V-phase, W-phase detection current). The estimated d-axis output current Ids and the estimated q-axis output current Iqs are also called “estimated d-axis estimated current Ids and estimated q-axis estimated current Iqs (or, estimated d-axis response current Ids and estimated q-axis response current Iqs)”.

The control unit BC includes an instruction current calculation block IC, an instruction voltage calculation block VC, a first coordinate transformation block ZC, a second coordinate transformation block ZS, and a speed estimation block WS.

In the instruction current calculation block IC, the estimated d-axis instruction current Idc and estimated q-axis instruction current Iqc are calculated on the basis of the instruction rotational speed ωc (target value of motor rotational speed) and the estimated rotation speed ωs (estimated value of motor rotational speed). Specifically, in the instruction current calculation block IC, the estimated rotation speed ωs calculated in the speed estimation block WS is subtracted from the instruction rotational speed ωc. Then, the estimated d-axis instruction current Idc to which the estimated d-axis output current Ids should follow is determined on the basis of the calculation result “ωc-ωs” (referred to as “rotational speed error Δω”). Furthermore, in the instruction current calculation block IC, the estimated q-axis instruction current Iqc to which the estimated q-axis output current Iqs should follow is calculated on the basis of the estimated d-axis instruction current Idc and the like. That is, the instruction currents Idc and Iqc in the estimated d-axis and the estimated q-axis are calculated such that the rotational speed error Δω becomes “0” and the estimated rotation speed ωs matches the instruction rotational speed ωc. The instruction current calculation block IC is a process for matching the estimated rotation speed ωs with the instruction rotational speed ωc, and functions as a “speed controller (controller for controlling the rotational speed)”.

In the instruction voltage calculation block VC, the estimated d-axis and estimated q-axis instruction voltages Vdc and Vqc (target values) are calculated on the basis of the estimated d-axis instruction current Idc and estimated q-axis instruction current Iqc (target values) and the estimated d-axis output current Ids and estimated q-axis output current Iqs (output values). In the instruction voltage calculation block VC, the instruction voltages Vdc and Vqc in the estimated d-axis and the estimated q-axis are calculated such that the current errors “Iqc-Iqs” and “Idc-Ids” in the estimated d-axis and the estimated d-axis both become “0” and the estimated d-axis Ids and estimated q-axis output current Iqs match the estimated d-axis instruction current Idc and estimated q-axis instruction current Iqc. Since the instruction voltage calculation block VC is a processing block for matching the estimated d-axis output current Ids and estimated q-axis output current Iqs with the estimated d-axis instruction current Idc and estimated q-axis instruction current Iqc, the instruction voltage calculation block VC functions as a “current controller (controller for controlling the estimated current)”.

In the first coordinate transformation block ZC, the U-phase, V-phase, and W-phase instruction voltages Vuc, Vvc, and Vwc (target values) are calculated on the basis of the estimated d-axis and estimated q-axis instruction voltages Vdc and Vqc (target values). Specifically, the estimated d-axis and estimated q-axis instruction voltages Vdc and Vqc are coordinate transformed from two phases to three phases on the basis of the estimated rotation angle θs calculated by the speed estimation block WS, whereby the U-phase, V-phase, and W-phase instruction voltages Vuc, Vvc, and Vwc are determined. The U-phase, V-phase, and W-phase instruction voltages Vuc, Vvc, and Vwc are output to the inverter INV.

In the inverter INV, power is supplied to the brushless motor BM by the PWM control (pulse width modulation control) on the basis of the U-phase, V-phase, and W-phase instruction voltages Vuc, Vvc, and Vwc, and the brushless motor BM is driven. Specifically, pulse width modulated signals are determined according to the U-phase, V-phase, and W-phase instruction voltages Vuc, Vvc, and Vwc. Then, the switching element (MOS-FET, IGBT, etc.) is controlled according to the signal, and the U-phase, V-phase, and W-phase supply currents Ius, Iuv, Iws (also referred to as “detection currents”) to the brushless motor BM are adjusted. That is, the U-phase, V-phase, and W-phase supply currents Ius, Iuv, and Iws are controlled as a result of the U-phase, V-phase, and W-phase instruction voltages Vuc, Vvc, and Vwc.

A current sensor IA is provided to detect the motor currents Ius, Iuv, Iws supplied from the inverter INV to the brushless motor BM. Since the phase differences among the U-phase, V-phase, and W-phase supply currents Ius, Iuv, and Iws are known, the supply currents (e.g., the U-phase detection current Ius and the V-phase detection current Ivs) of two phases of the three phases may be detected by the current sensor IA, and the supply current (e.g., the W-phase detection current Iws) of the remaining one phase may be estimated. That is, the currents actually supplied to the three phases are detected by detecting the supply currents of at least two phases of the three phases by the current sensor IA.

In the second coordinate transformation block ZS, the estimated d-axis output current Ids and the estimated q-axis output current Iqs are calculated on the basis of the U-phase, V-phase, and W-phase detection currents Ius, Iuv, and Iws.

Specifically, the detection currents Ius, Iuv, and Iws are coordinate transformed from three phases to two phases on the basis of the estimated rotation angle θs calculated by the speed estimation block WS, whereby the estimated d-axis output current Ids and estimated q-axis output current Iqs are determined.

Here, the estimated d-axis output current Ids and the estimated q-axis output current Iqs (output values) correspond to the estimated d-axis instruction current Idc and the estimated q-axis instruction current Iqc (input values, target values).

In the speed estimation block WS, the estimated rotation speed ωs and the estimated rotation angle θs are calculated on the basis of the estimated d-axis output current Ids and the estimated q-axis output current Iqs. In the speed estimation block WS, first, the estimated rotation speed ωs is calculated. Then, the estimated rotation speed ωs is then integrated to determine the estimated rotation angle θs. For the calculation of the estimated rotation speed ωs, a known method such as a current drawing method, a harmonic wave superposition method, a magnetic flux observer method, or an expansion induced voltage method is adopted.

For example, in the speed estimation block WS, as indicated by the balloon section XWS, the control amount of the PLL control when the axial error Δθ is controlled to follow “0 (target value)” is determined as the estimated rotation speed ωs. Here, in the phase locked loop (PLL) control, feedback control is applied on the basis of an input periodic signal, and a phase-synchronized signal is output from another oscillator.

Since the target value of the axial error Δθ is set to “0”, the axial error Δθ is input to the PLL control block. In the PLL control block, the axial error Δθ is multiplied by a proportional gain Kp to calculate a proportional term. In addition, the axial error Δθ is time integrated and multiplied by an integration gain Ki to calculate an integral term. Then, the sum of the proportional term and the integral term is determined as the estimated rotation speed ωs (i.e., “ωs=Kp·Δθ+Ki·∫Δθ·dt”) . Furthermore, the estimated rotation speed ωs is time integrated to determine an estimated rotation angle θs (i.e., “θs=∫ωs·dt”).

For example, in the speed estimation block WS, the calculation method of the axial error Δθ (angle error between the real q-axis and the estimated q-axis) is selectively used on the basis of the rotational speed. When the rotational speed is small (at time of low speed), the axial error Δθ is determined on the basis of the harmonic wave superposition method. In the harmonic wave superposition method (also referred to as “disturbance superposition method”), the high frequency voltage of the pulse (or a sinusoidal wave,) is superimposed (applied) on the estimated d-axis instruction voltage Vdc. Then, the axial error Δθ is estimated on the basis of the amplitude change of the high frequency component of the estimated q-axis output voltage Iqs at this time.

On the other hand, when the rotational speed is high (at time of high speed), the axial error Δθ is calculated on the basis of the expansion induced voltage method. In the expansion induced voltage method, an axial error Δθ (angle error) is calculated by estimating an induced voltage from a voltage and a current. Specifically, the axial error Δθ is estimated on the basis of the estimated rotation speed ωs (previous value in the calculation cycle), the estimated d-axis output current Ids and the estimated q-axis output current Iqs, and the estimated d-axis and estimated q-axis instruction voltages Vdc and Vqc.

The estimated rotation speed ωs calculated by the speed estimation block WS is input to the instruction current calculation block IC and the determination unit BH.

Furthermore, the estimated rotation angle es calculated by the speed estimation block WS is input to the first and second coordinate transformation blocks ZC and ZS.

### Determination Unit BH

The determination unit BH determines the presence or absence of step-out in the brushless motor BM. In a brushless motor including a rotation angle sensor, a coil phase optimum for torque generation is always determined on the basis of information on the rotation angle, and thus step-out (asynchronization between a rotating magnetic field and a rotor having a permanent magnet) does not occur. However, in a brushless motor not including a rotation angle sensor, synchronization between a rotating magnetic field and a rotor is performed by estimation, and thus step-out may occur at the time of high load, sudden change in load, or the like.

In the determination unit BH, presence or absence of occurrence of step-out is determined on the basis of the estimated rotation speed ωs, the estimated q-axis instruction voltage Vqc, the estimated d-axis output current Ids and the estimated q-axis output current Iqs. Then, when the occurrence of step-out is determined, the determination signal Fd is output toward the instruction current calculation block IC. For example, the determination signal Fd is transmitted as a control flag (also referred to as a “determination flag”).

Specifically, in the determination flag Fd, “0” indicates that step-out has not occurred, and “1” indicates that step-out has occurred. Therefore, the time point (corresponding calculation cycle) at which the transition from “Fd=0” to “Fd=1” occurs is the step-out occurrence time point.

In the instruction current calculation block IC of the control unit BC, a process of recovering the step-out state is executed on the basis of the determination flag Fd. For example, from the time point when “Fd=1” is received, the instruction rotational speed ωc is decreased.

### Details of Determination Unit BH

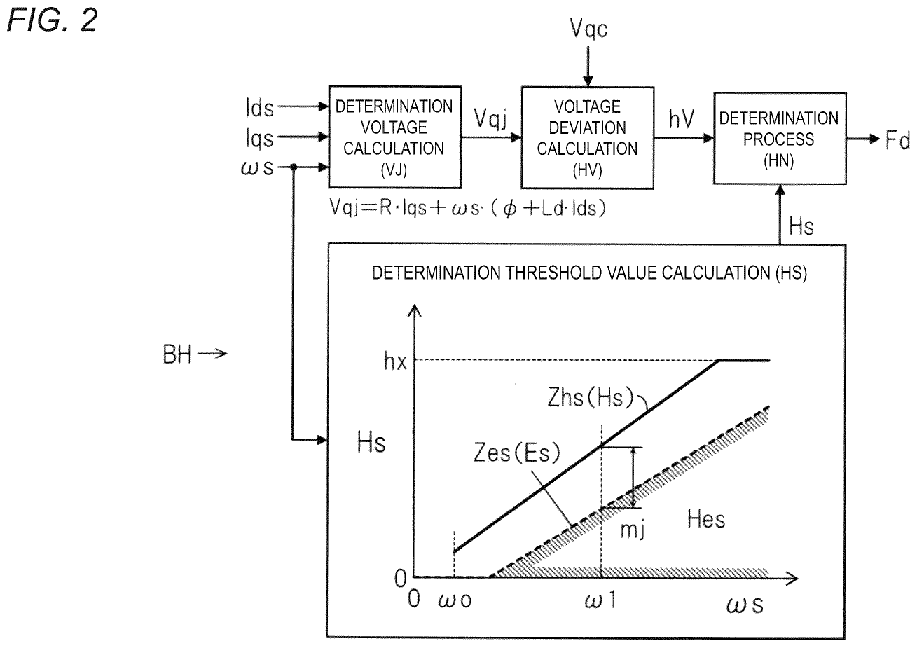

Details of the determination unit BH will be described with reference to the block diagram of FIG. 2. The estimated rotation speed ωs, the estimated q-axis instruction voltage Vqc, and the estimated d-axis output current Ids and the estimated q-axis output current Iqs are input to the determination unit BH. The determination unit BH calculates a deviation hV (voltage deviation) between the determination voltage Vqj calculated from the estimated rotation speed ωs, and the estimated d-axis output current Ids and the estimated q-axis output current Iqs, and the estimated q-axis instruction voltage Vqc. Then, the presence or absence of step-out of the brushless motor BM is determined by comparing the voltage deviation hV with the determination threshold value Hs.

The determination unit BH includes a determination voltage calculation block VJ, a voltage deviation calculation block HV, a determination threshold value calculation block HS, and a determination processing block HN.

In the determination voltage calculation block VJ, the determination voltage Vqj is calculated on the basis of the estimated rotation speed ωs, and the estimated d-axis output current Ids and the estimated q-axis output current Iqs. The “determination voltage Vqj” is a voltage to be applied to the estimated q-axis when it is assumed that the brushless motor BM is not out of step and is rotating at the estimated rotation speed ωs. Specifically, the determination voltage Vqj is determined on the basis of Equation (1).

Vqj=R·Iqs+ωs·(Q+Ld·Ids) Equation (1)

Here, “R” represents a resistance value (nominal value) of the brushless motor BM, “φ” represents an interlinkage magnetic flux (nominal value) of the brushless motor BM, and “Ld” represents a d-axis inductance (nominal value) of the brushless motor BM. Here, the “nominal value” is an average value of the actually measured data.

A first term Sv1 (=“R·Iqs”) in Equation (1) corresponds to a voltage drop in the brushless motor BM when the estimated q-axis output current Iqs is energized. In addition, the second term Sv2 (=“ωs·(φ+Ld·Ids) ”) of Equation (1) corresponds to the counter electromotive voltage in the brushless motor BM when rotated at the estimated rotation speed ωs. Therefore, in the calculation of the determination voltage Vqj, the first term Sv1 (also referred to as “first component”) corresponding to the voltage drop in the brushless motor BM is calculated on the basis of the estimated q-axis output current Iqs. Furthermore, a second term Sv2 (also referred to as a “second component”) corresponding to the counter electromotive voltage in the brushless motor BM is calculated on the basis of the estimated rotation speed ωs and the estimated d-axis output current Ids. Then, the sum of first component Sv1 and second component Sv2 is determined as the determination voltage Vqj.

In the voltage deviation calculation block HV, a voltage deviation hV that is a difference between the determination voltage Vaj and the estimated q-axis instruction voltage Vqc is calculated on the basis of the determination voltage Vqj and the estimated q-axis instruction voltage Vqc. For example, the voltage deviation hV is determined on the basis of Equation (2).

hV=Vqj−Vqc Equation (2)

As described above, the determination voltage Vqj is a voltage corresponding to the estimated q-axis instruction voltage Vqc in a state in which step-out has not occurred and the brushless motor BM is appropriately operated at the estimated rotation speed ωs. Therefore, the voltage deviation hV, which is the difference between the determination voltage Vaj and the estimated q-axis instruction voltage Vqc, is a state quantity (state variable) representing the extent (degree) of step-out. Therefore, the voltage deviation hV is calculated to be larger the larger the extent of step-out of the brushless motor BM (the difference between the instruction rotational speed ωc and the actual motor rotational speed).

For example, in a state in which the brushless motor BM is appropriately driven by sensorless control without being stepped out (i.e., state in which the estimated rotation speed ωs substantially matches the actual motor rotational speed.), the estimated q-axis instruction voltage Vqc and the determination voltage Vaj are equal to each other. Therefore, in this state, the voltage deviation hV is “0”. On the other hand, in a state in which the brushless motor BM is stepped out and the rotation is completely stopped (i.e., state in which the estimated rotation speed ωs is generated, but the actual rotational speed is “0”), the estimated q-axis instruction voltage Vqc does not include second component Sv2 corresponding to the counter electromotive voltage. Thus, the voltage deviation hV matches the second component Sv2. Therefore, when the brushless motor BM is stepped out and the actual motor rotational speed is “0”, “hV=ωs·(φ+Ld·Ids)=Sv2” is calculated. That is, the maximum value of the voltage deviation hV is the second component Sv2, and the voltage deviation hV changes in a range from “0” to the second component Sv2.

In the determination threshold value calculation block HS, the determination threshold value Hs is calculated on the basis of the estimated rotation speed ωs. The “determination threshold value Hs” is a threshold value for determining the presence or absence of step-out. A calculation map Zhs, which is a characteristic for calculating the determination threshold value Hs, is set in advance as a characteristic of the determination threshold value Hs with respect to the estimated rotation speed ωs. The characteristic Zhs is then stored in a microprocessor in the motor control device MS. The determination threshold value Hs is determined according to the calculation map Zhs set in advance so as to become larger the larger the estimated rotation speed ωs.

As described above, when the brushless motor BM is appropriately operated (i.e., when step-out has not occurred), the determination voltage Vqj is equal to the estimated q-axis instruction voltage Vqc, and thus the voltage deviation hV is determined to be “0”. However, in the motor control device MS, the detection results Ius, Ivs, Iws (current detection values) of the current sensor IA include variations (errors).

Similarly, in the brushless motor BM as well, there are variations in the resistance value R, the interlinkage magnetic flux φ, and the inductances Ld and Lq (induction coefficients) of the d-axis and the q-axis. Furthermore, the detection value (Ius etc.) of the current sensor IA and the characteristic (R, (φ, etc.) of the brushless motor BM fluctuates depending on the temperature or the like. Therefore, in a state in which the brushless motor BM is not out of step (i.e., the state of “hV=0”), the characteristic Zes of the error Es included in the sensorless control is calculated in advance. The error Es is referred to as a “steady state error”, and its characteristic Zes is referred to as a “steady state error characteristic”.

The steady state error Es is an error included in the sensorless control in a steady state due to an error (variation and fluctuation) such as a detection value of the current sensor IA and a characteristic of the brushless motor BM.

The maximum value (worst value) of the steady state error Es is determined for each motor rotational speed using the motor rotational speed as a parameter in the combination of the variation and the temperature condition. Then, the maximum value of the steady state error Es is plotted with respect to the motor rotational speed, and the steady state error characteristic Zes is set. That is, the steady state error Es occurs in a range Hes (referred to as a “steady state error range”) surrounded by the horizontal axis (the axis of the estimated rotation speed ωs) and the steady state deviation characteristic Zes.

The calculation map Zhs for calculating the determination threshold value Hs is set to be always larger than the steady state error characteristic Zes. Specifically, a predetermined margin (margin value) is added to the steady state error characteristic Zes to set the calculation map Zhs. As a result, for example, when the estimated rotation speed ωs is the value ω1, the determination threshold value Hs according to the calculation map Zhs is calculated to be larger than the steady state error Es corresponding to the steady state error characteristic Zes by the margin value mj. Since the determination threshold value Hs is not included in the range Hes (steady state error range) of the steady state error Es, step-out can be accurately determined.

In the steady state error characteristic Zes, the steady state error Es becomes larger the higher the motor rotational speed. In order to efficiently avoid the determination threshold value Hs from being included in the error range of the steady state error Es, the calculation map Zhs is set to be larger the larger the estimated rotation speed ωs. Furthermore, the calculation map Zhs is provided with an upper limit value hx. In addition, in the calculation map Zhs, a lower limit speed ωo is provided so that the step-out determination is restricted when the estimated rotation speed ωs is low. That is, when the estimated rotation speed ωs is less than the lower limit speed ωo, the determination related to step-out is not executed. Here, the “upper limit value hx” and the “lower limit speed ωo” are predetermined values (constants) set in advance.

In the determination processing block HN, the presence or absence of step-out is determined on the basis of the comparison between the voltage deviation hV and the determination threshold value Hs. This determination is called “step-out determination”. In the determination processing block HN, step-out determination is performed on the basis of “whether or not the voltage deviation hV has reached the determination threshold value Hs”. Specifically, when the voltage deviation hV is less than the determination threshold value Hs, the occurrence of step-out is denied. On the other hand, when the voltage deviation hV is greater than or equal to the determination threshold value Hs, the time Tx (referred to as “duration”) is counted during which the state (i.e., state in which the voltage deviation hV has reached the determination threshold value Hs) is continued from the time point (corresponding calculation cycle) when it is satisfied for the first time. Then, when the duration Tx of the state of “hV>Hs” has reached the determination time tx, the occurrence of step-out is affirmed.

Here, the “determination time tx” is a predetermined value (constant) set in advance. In the determination processing block HN, “Fd=0” is output when the occurrence of step-out is denied, and “Fd=1” is output when the occurrence of step-out is affirmed.

A method of determining the determination threshold value Hs will be summarized. The determination threshold value Hs is calculated on the basis of the estimated rotation speed ωs and a preset calculation map Zhs. The determination threshold value Hs is determined to be larger the larger (higher) the estimated rotation speed ωs according to the calculation map Zhs. The calculation map Zhs is set to be larger than the steady state error characteristic Zes. As a result, the determination threshold value Hs is determined so as to always be larger than the steady state error Es included in the sensorless control.

As a result, the influence of the steady state error Es is reduced in the step-out determination.

### Summary of Embodiments

Hereinafter, embodiments of the motor control device MS will be summarized.

The motor control device MS includes a control unit BC that performs sensorless control of the brushless motor BM having three phases, and a determination unit BH that determines the presence or absence of step-out of the brushless motor BM. In the control unit BC, the sensorless control is executed on the basis of the estimated d-axis output current Ids and the estimated q-axis output current Iqs, the estimated d-axis and estimated q-axis instruction voltages Vdc and Vqc, and the estimated rotation speed ωs. Here, the estimated d-axis output current Ids and the estimated q-axis output current Iqs are calculated from the detection currents (i.e., at least two of the detection currents Iua, Iva, and Iwa) of at least two phases among the three phases. The estimated d-axis and estimated q-axis instruction voltages Vdc and Vqc are determined on the basis of the estimated d-axis output current Ids and the estimated q-axis output current Iqs. The estimated rotation speed ωs is determined on the basis of the estimated d-axis output current Ids and the estimated q-axis output current Iqs.

In the determination unit BH, the determination voltage Vqj is calculated on the basis of the estimated d-axis output current Ids and the estimated q-axis output current Iqs, and the estimated rotation speed ωs. When voltage deviation hV, which is a difference between determination voltage Vqj and estimated q-axis instruction voltage Vqc, reaches determination threshold value Hs (i.e., in a case where the voltage deviation hV is greater than or equal to the determination threshold value Hs), the occurrence of step-out is determined. The determination threshold value Hs is determined so as to become larger the larger the estimated rotation speed ωs. Since the determination voltage Vaj used for the step-out determination is calculated on the basis of the estimated rotation speed ωs, the determination error is reduced.

In the determination unit BH, the determination voltage Vqj is determined on the assumption that the brushless motor BM is not out of step and is rotating at the estimated rotation speed ωs. Specifically, the determination voltage Vqj is calculated as a sum of the first component Sv1 corresponding to the voltage drop in the brushless motor BM and the second component Sv2 corresponding to the counter electromotive voltage in the brushless motor BM (i.e., “Vqj=Sv1+Sv2”). Here, the first component Sv1 is calculated on the basis of the estimated q-axis output current Iqs (specifically, “Sv1=R·Iqs”). The second component Sv2 is calculated on the basis of the estimated rotation speed ωs and the estimated d-axis output current Ids (specifically, “Sv2=ωs·(φ+Ld·Ids) ”).

The determination voltage Vaj is determined so as to correspond to a state in which step-out does not occur and the motor rotational speed is the estimated rotation speed ωs.

Therefore, the voltage deviation hV, which is a difference between the determination voltage Vqj and the estimated q-axis instruction voltage Vqc, represents the extent (magnitude) of step-out. Specifically, in the voltage deviation hV, the extent of step-out is expressed according to the change in the second component Sv2 corresponding to the counter electromotive voltage. For example, when the brushless motor BM is normally driven (i.e., when step-out has not occurred), the voltage deviation hV is determined to be “0”. On the other hand, a case where the brushless motor BM is completely stopped (i. e., when the motor rotational speed is “0”,) is the worst state in step-out. Since no counter electromotive voltage is generated in the worst state, the voltage deviation hV is determined to be equal to the second component Sv2. With the above configuration, the degree of step-out of the sensorless brushless motor BM is appropriately expressed, so that reliable step-out determination is executed.

In the determination unit BH, the calculation map Zhs for calculating the determination threshold value Hs is set to be larger than the characteristic Zes (steady state error characteristic) of the error Es included in the sensorless control. As a result, the determination threshold value Hs is always calculated to a value larger than the steady state error Es. That is, the determination threshold value Hs is not included in the steady state error range Hes and is determined outside the steady state error range Hes. As a result, the influence of the steady state error Es is avoided in the step-out determination.

In the steady state error characteristic Zes, the steady state error Es increases with increase in the motor rotational speed. In addition, the second component Sv2 representing the step-out degree changes according to the estimated rotation speed ωs. Therefore, in the calculation map Zhs for calculating the determination threshold value Hs, the determination threshold value Hs is determined as a larger value the larger the estimated rotation speed ωs. As a result, the determination threshold value Hs can efficiently avoid the steady state error range Hes, and the step-out determination can be appropriately executed.

In the determination unit BH, the execution of the step-out determination is prohibited when the estimated rotation speed ωs is less than a predetermined speed ωo set in advance. When the motor rotational speed is low, it is difficult to ensure the accuracy of the estimated rotation speed ωs. In addition, when the motor rotational speed is low, the probability of step-out occurrence is low as compared with when the motor rotational speed is high. Therefore, when “ωs<ωo”, the step-out determination is not executed. As a result, the reliability of step-out determination is improved.

1. A motor control device comprising:
a control unit that performs sensorless control of a brushless motor having three phases; and
a determination unit that determines presence or absence of step-out of the brushless motor; wherein
the control unit executes the sensorless control on the basis of estimated d-axis and estimated q-axis output currents, estimated d-axis and estimated q-axis instruction voltages, and an estimated rotation speed;
the determination unit calculates a determination voltage on the basis of the estimated d-axis and estimated q-axis output currents, and the estimated rotation speed, and
occurrence of the step-out is determined when a voltage deviation, which is a difference between the determination voltage and the estimated q-axis instruction voltage, reaches a determination threshold value.

2. The motor control device according to claim 1, wherein
the determination unit determines the determination threshold value to be larger the larger the estimated rotation speed.

3. The motor control device according to claim 2, wherein
the determination unit determines the determination voltage on the assumption that the brushless motor is not out of step and is rotating at the estimated rotation speed.

4. The motor control device according to claim 3, wherein
the determination unit,
calculates a first component corresponding to a voltage drop in the brushless motor on the basis of the estimated q-axis output current; calculates a second component corresponding to a counter electromotive voltage in the brushless motor on the basis of the estimated rotation speed and the estimated d-axis output current; and
determines the determination voltage as a sum of the first component and the second component.

5. The motor control device according to claim 1, wherein
the determination unit determines the determination voltage on the assumption that the brushless motor is not out of step and is rotating at the estimated rotation speed.

6. The motor control device according to claim 5, wherein
the determination unit,
calculates a first component corresponding to a voltage drop in the brushless motor on the basis of the estimated q-axis output current; calculates a second component corresponding to a counter electromotive voltage in the brushless motor on the basis of the estimated rotation speed and the estimated d-axis output current; and
determines the determination voltage as a sum of the first component and the second component.
